(19) United States
(12) Patent Application Publication
(10) Pub. No.: US 2015/0347832 A1
(43) Pub. Date: Dec. 3, 2015

(54) SYSTEM AND METHOD FOR PLEOGRAPHIC SUBJECT IDENTIFICATION, TARGETING, AND HOMING UTILIZING ELECTROMAGNETIC IMAGING IN AT LEAST ONE SELECTED BAND

(71) Applicant: Michael Shutt, Ewing, NJ (US)

(72) Inventor: Michael Shutt, Ewing, NJ (US)

(21) Appl. No.: 14/822,979

(22) Filed: Aug. 11, 2015

Related U.S. Application Data
(63) Continuation of application No. 13/040,335, filed on Mar. 4, 2011, now abandoned.
Application No. 13/040,335 is a continuation-in-part of application No. 12/558,520, filed on Sep. 14, 2009, now abandoned.
(60) Provisional application No. 61/310,694, filed on Mar. 4, 2010.
(60) Provisional application No. 61/191,836, filed on Sep. 12, 2008.

(51) Int. Cl. G06K 9/00

(52) U.S. Cl. CPC G06K 9/00369

(57) ABSTRACT

The inventive data processing system and method enable automatic recognition of images captured using various electromagnetic (EM) imaging systems and techniques, and more particularly to a system and method for applying pleographic processing for subject identification recognition, matching, targeting, and or homing, utilizing one or more EM imaging systems, devices, in at least one selected EM band.

### CROSS REFERENCE TO RELATED APPLICATIONS

The present patent application claims priority from, and is the continuation of, the commonly assigned U.S. patent application Ser. No. 13/040,335 entitled “System and Method for Pleographic Subject Identification, Targeting, and Homing Utilizing Electromagnetic Imaging in at Least One Selected Band”, filed Mar. 4, 2011, which in turn claims priority from U.S. provisional patent application No. 61/310,694 entitled “System and Method for Pleographic Subject Identification, Targeting, and Homing Utilizing Electromagnetic Imaging in at Least One Selected Band”, filed Mar. 4, 2010, and which was also a continuation-in-part of, and claimed priority from, the commonly assigned U.S. patent application Ser. No. 12/558,520 entitled “System and Method for Pleographic Recognition, Matching, and Identification of Images and Objects”, filed on Sep. 14, 2009, which in turn claims the benefit from the commonly assigned expired U.S. provisional patent application No. 61/191,836 entitled “Pleographic Recognition Technology for Object Matching and Identification”, filed on Sep. 12, 2008.

### FIELD OF THE INVENTION

The present invention relates generally to data processing systems and methods for automatic recognition of images captured using various electromagnetic (EM) imaging systems and techniques, and more particularly to a system and method for applying pleographic processing for subject identification, recognition, matching, targeting, and/or homing, utilizing one or more EM imaging systems, devices, in at least one selected EM band.

### BACKGROUND OF THE INVENTION

There is a significant need in a wide variety of military, law enforcement and commercial (e.g., security, access control, etc.) applications for a way of remotely identifying, recognizing, and/or matching various subjects utilizing various imaging techniques. Military applications also have additional unique requirements for image-based targeting and/pr homing of various subjects. Additionally, while the goals of detection of presence and movement of subjects, as well as general identification of subject type/profile are useful, there is also a great need for a capability of using remote biometric identification to identify/match specific subjects remotely without need for their cooperation.

Furthermore, infrared (IR) cameras and thermal imagers were originally developed for military use and have slowly migrated into other fields as varied as electrical inspections, energy home inspection audits and a wide array of applications. Advanced optics and sophisticated software interfaces continue to enhance the versatility of these devices. Thermal/IR cameras are used for night vision applications that are employed extensively by the United States armed forces. Thermal/IR cameras are incorporated into many air, sea and land vehicles. Military thermal imaging is used for remote sensing, night vision, weapon sighting, perimeter security, installation surveillance & force protection among other applications.

Therefore, given the availability, reasonable cost, useful “night vision” capabilities of infrared and thermal imaging systems, as well as unique “through-a-barrier” capabilities of thermal imaging systems, it is also very desirable to be able to apply the functionality of biometric recognition/verification techniques to such no conventional imaging capabilities.

However, conventional visual spectrum image processing/recognition techniques are of very limited use with thermal IR images which contain far less uniquely identifiable information than conventional images. Fortunately, a novel patent-pending Pleographic Image Analysis (PIA) technology platform, and its modular components, shown and described in a co-pending commonly assigned U.S. Patent Application entitled “SYSTEM AND METHOD FOR PLEOGRAPHIC RECOGNITION, MATCHING, AND IDENTIFICATION OF IMAGES AND OBJECTS”, application Ser. No. 12/558,520, (hereinafter the '520 Application), which is hereby incorporated by reference herein in its entirety.

The above-incorporated '520 Application remedies the disadvantages of all previously known and currently available image analysis and biometric solutions, by providing a platform-independent image analysis system architecture and technology platform comprising a plurality of scalable novel image/object recognition and processing techniques that are capable of dramatically improving the efficacy, reliability, and accuracy of conventional and future surveillance, detection, identification, verification, matching navigation, and similar types of systems utilizing image acquisition analysis of any kind. Furthermore, the use of the novel pleographic platform solutions taught and described in the '520 Application, advantageously provides unequaled levels of tolerance to degradation in quality, decrease in available portion, increased noise, and variation in positioning and/or orientation in the images being analyzed as compared to the corresponding reference image(s), regardless of the EM band(s) in which the images were captured.

Therefore, it would be very desirable to provide a system and method for application of pleographic image processing techniques for subject identification, recognition, matching, targeting, and/or homing, utilizing one or more EM imaging systems, devices, in at least one predetermined selected EM band (such as IR, thermal imaging, etc.).

### BRIEF DESCRIPTION OF THE DRAWINGS

In the drawings, wherein like reference characters denote corresponding or similar elements throughout the various figures:

FIG. 1 shows exemplary infrared (IR) images of a human body utilized in the operation of at least one exemplary embodiment of the system and method of the present invention;

FIGS. 2 and 3 show exemplary joint matching between various exemplary IR EM band images of FIG. 1, above;

FIG. 4 shows exemplary thermal images of a human body utilized in the operation of at least one exemplary embodiment of the system and method of the present invention;

FIG. 5 shows exemplary BTP Grayscale images of a human body utilized in the operation of at least one exemplary embodiment of the system and method of the present invention;

FIG. 6 shows exemplary joint matching between various exemplary BTP Grayscale EM band images of FIG. 5, above;

FIG. 7 shows a reference pleogram (a), and a central fragment thereof (b), generated and utilized in various embodiments of the system and method of the present invention;

FIG. 8 shows a matched pleogram between two specific BTP Grayscale images of FIG. 5; and

FIG. 9 shows an actual match between two specific BTP Grayscale images of FIG. 5.

### SUMMARY OF THE INVENTION

The various embodiments of the system and method of the present invention are directed to applications of pleographic image processing techniques, such as disclosed in the '520 Application, for subject identification, recognition, matching, targeting, and/or homing, utilizing one or more EM imaging systems, devices, in at least one predetermined selected EM band (such as IR, thermal imaging, etc.), to essentially provide an advanced biometric technology based on IR/thermal image utilization (described herein by way of example only, in the context of a remote personnel identification application).

The use of the pleographic image processing (PIP) platform of the '520 Application (incorporating novel image comparison approaches based on 3D identification procedures) which, inter alia, improves the efficacy of existing observation, detection, and identification systems, grill advantageously substantially increase target identification reliability, while reducing processing time and camera and image resolution requirements.

This PIP platform recognition technique is primarily focused on reliable object capture and identification against a pre-accumulated reference library/database, which in the case of the present invention, by way of example may be IR Body Thermal Patterns. The PIP platform recognition technique is especially effective under conditions with strong real-time limitations, such as uncertain object positions, arbitrary signal distortions, and others, because it utilizes novel spatial response surfaces—herein called pleograms—that are unique for each observed image that are used for matching.

Due to an inherent redundancy, quite comparable with holographic measurements, pleograms are extremely informative and stable making this technique practically immune to strong image distortions that are typical for remote human surveillance. Additionally, the PIP platform recognition technique provides high reliability in comparison with raw image matching. The ID procedures exploited in this technique remain workable even if body thermal patterns (BTP) are partially degraded and measurements are corrupted. This matching technique is image source independent and applicable to most remote measurements and imaging in virtually any EM radiation band, such as optical (e.g. visible light, infrared, laser, X-ray, radar, lidar, etc Additionally, the PIP platform recognition method is ID area independent so it may be applied to the head/facial zone, chest, shoulders, or entire body, etc.

High reliability and accuracy of the PIP platform recognition method and system providing implementation thereof, are claimed and demonstrated. It is important to note that no cooperation from the subject is required.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The inventive data processing system and method enable automatic recognition of images captured using various electromagnetic (EM) imaging systems and techniques, and more particularly to a system and method for applying pleographic processing for subject identification, recognition, matching, targeting, and or homing, utilizing one or more EM imaging systems, devices, in at least one selected EM band.

It should be noted that in various illustrative examples below, thermal images have been obtained using a conventional compact infrared camera meeting appropriate dust and splashproof standards, that is insensitive to visible light, and that is thus capable of working equally well in a bright sunny environment as well as in total darkness.

### 1. Brief Scientific Discussion

### 1.1. System Requirements

For practical implementation, in the system and method of the present invention, of the '520 Application pleographic approach using IR, a human phenomenology or signature must be defined and justified to provide the following features:
1. A range of acquisition as far as possible.
2. Acquisition requires minimal/negligible cooperation from the subject.
3. A novel biometric signature that must be unique for the subject and that is observable independent of a disguised feature (clothes, glasses, beard, etc).

Infrared radiation can be used to remotely capture the human IR pattern as a thermal picture. Thermography (thermal imaging) is mainly used in military and industrial applications; the range of modern highly sensitive thermal cameras is limited practically by the direct vision distance. For example, a typical Military-grade infrared handheld unit can detect a human object at 16 km

### 1.2. Thermal Imaging

Thermographic cameras detect radiation in the infrared range of the electromagnetic spectrum (roughly 900-14,000 nanometers or 0.9-14 μm) and produce images of that radiation field. Since infrared radiation is emitted by all objects based on their temperatures, thermography makes it possible to observe one's environment without any illumination.

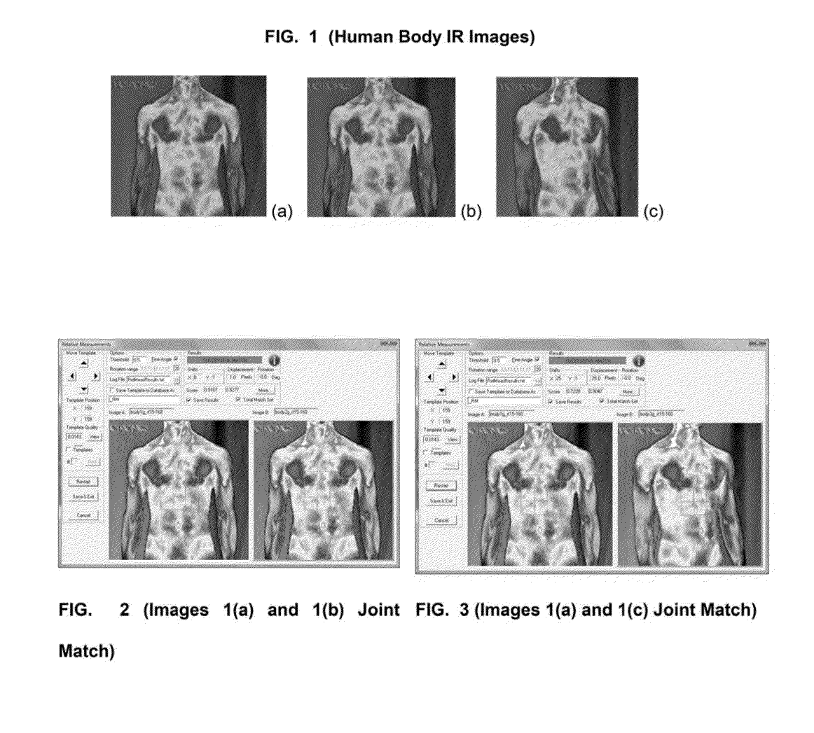

Sample human body IR images are shown FIG. 1. For an initial example, image (a) is considered as a reference, images (b) and (c) are the captured ones in the process of surveillance (realizing that these are closer than many practical applications).

As it is seen from the FIG. 1 images, specific inherent thermal areas are available for observation and further ID under conditions of different view angles and body positioning. The observed images are referred to below as Body Thermal Patterns (BTP).

The BTP uniqueness and usability for the subject ID have yet to be developed and proven; however, initial testing (see Experimental Data section below) has resulted in promising outcomes.

### 1.3. Spatial Recognition for Subject Identification

The system and method of the present invention are based on a novel core approach to object recognition development, described in this section below, that resolves existing problems in the remote subject identification, etc. field including, but not limited to: 1) Algorithm synthesis for the arbitrary nature of real observations; 2) Reconciling the inherent discordance between reference data and real-time observations; 3) Countering of unpredictable geometric distortions such as angle variations, rotations, and non-linear scale variations; and 4) Ability to work under conditions of poor lightning, low contrast, and poor resolution.

The inventive pleogram recognition and matching technology and algorithms (such as disclosed in the '520 Application) provide one or more unique advantages, that may include, but that are not limited to, at least one of the following advantages:
The method uses all available information about the observations
No specific assumption regarding the noise distributions are required—any arbitrary distortions are admissible for statistically optimal algorithm synthesis
Ability to work with low quality object images due to the pleogram redundancy
Significant tolerance to imperfect ages and conditions the image could be strongly damaged
Relatively low pipeline computations and increase in processing speed
Low requirements on the object's spatial uncertainty
Satisfied reliability under conditions of partially degraded sensors

### 2. Predicted Accuracy and Stability of the Phenomenology

### 2.1. Experimental Data

Reciprocal recognition has been conducted for the images displayed in FIG. 1 after a grayscale transform. Images (a) and (b) are approximately of the same position (although some BTP differences are seen); image (a) is considered as a reference. Image (c) is rotated by ˜20 degrees. Joint match between images (a) and (b) with the use of a simplified binary algorithms [1] are shown in FIG. 2 and FIG. 3. in FIG. 2 the left image is a reference; the small green squares indicate a reference fragment automatically selected (in this case just from the image center).

The matching metrics may be displayed in a window entitled Score. As it can be seen, the match score is high (about 0.92 where the ideal score is equal to 1.0) and recognition provides a low shift. This allows estimating match outcomes as successful and reliable.

Close results are shown for images 1(a) and 1(c) joint match (see FIG. 3). The right match is obvious and is deemed as reliable. Due to the body rotation the matching Score is noticeably lower (0.72).

### 2.2. Method of Acquisition and Predicted Acquisition Time

### Thermal Images

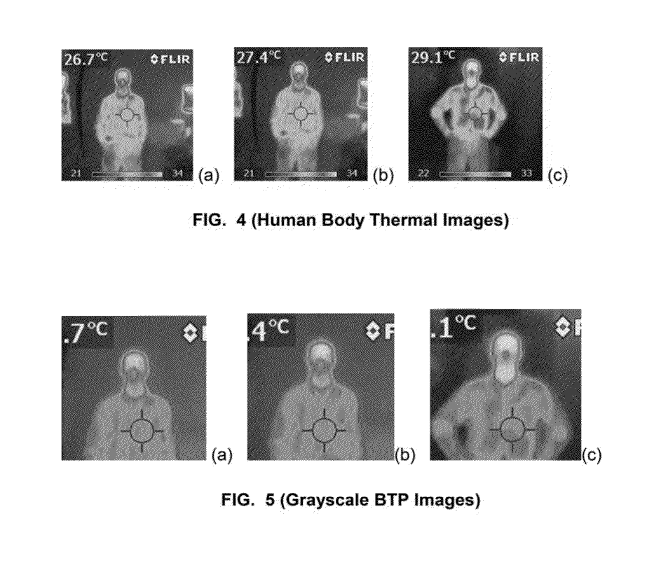

Most industrial thermal cameras that can readily be used for thermal image capture, performs such capture practically instantly. The capture range may vary depending on need (but for exemplary images illustrated in the various FIGs., the capture range was approximately 30 ft). The captured images of the same person are shown in FIG. 4, while the grayscale BTP images (after a camera zoom) are shown in FIG. 5.

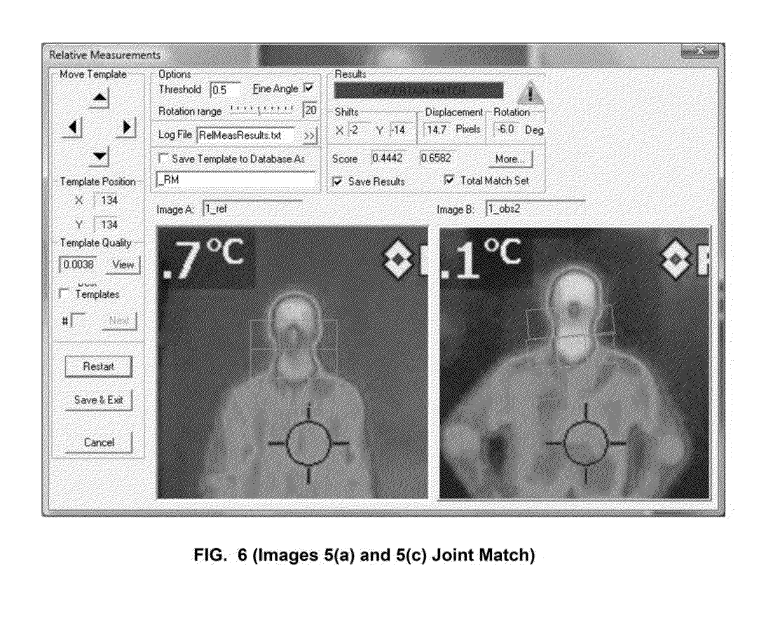

Joint mapping of images 5(a) and 5(b) runs successfully and reliably; at the same time, reciprocal recognition of images 5(a) and 5(c) using simplified algorithms (i.e., not using the novel PIP approach) provides an uncertain match, as is seen in FIG. 6.

### 2.3. Pleographic Image Matching

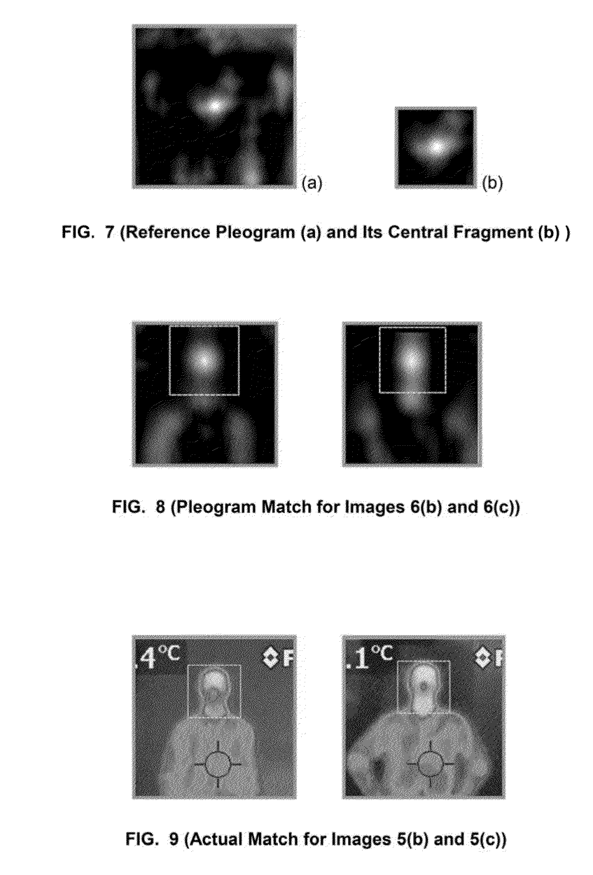

The substantially more powerful pleographic techniques of the system and method of the present invention, advantageously provide much more desirable results. The pleogram for the reference FIG. 5(a), appears as image (a) in the FIG. 7.

Its central fragment 7(b) is later used for matching against corresponding pleograms for images 5(b) and 5(c). Matching results are shown by way of example in FIG. 8 (a PIP program's operation is indicated by yellow squares).

Matching scores of 0.996 and 0.948, respectively, clearly demonstrate and prove that the novel PIP methodology achieves reliable recognition. When referenced back to the original images from FIG. 5, the PIP program provides the regions snatched in FIG. 9).

High scores and visually correct match positioning define the accurate and reliable object identification by the inventive system and method, with the expected correct recognition probability being greater than 0.9.

### 3. Key Points and Conclusions Relating to the Inventive System and Method

1. IR thermal human body signature is an attractive candidate technology for reliable personnel identification; existing IR cameras are usable for these purposes.
2. Predicted minimum/maximum range of subject in proximity to sensor: the BTP acquisition range is limited by the minimum focus distance of 1-2 ft and direct vision distance only. The uniqueness of long-distance pleograms based on human IR images needs to be determined.
3. BTP capture can occur in real time as a regular photo, i.e. practically instantaneously. No cooperation from the subject is required.
4. Mechanisms to potentially increase range between subject and sensor: the method and hardware allows the focus distance variations accommodating to a desirable BTP acquisition range.

Thus, while there have been shown and described and pointed out fundamental novel features of the invention as applied to preferred embodiments thereof, it will be understood that various omissions and substitutions and changes in the form and details of the devices and methods illustrated, and in their operation may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A data processing method, implemented in conjunction with at least one electromagnetic imaging system that is operable to capture at least one image, of at least one predetermined subject, in at least one predetermined electromagnetic band, comprising the steps of:
(a) capturing, by the at least one electromagnetic imaging system, the at least one image in the at least one predetermined electromagnetic band, as at least one subject image:
(b) applying at least one pleographic image processing technique to process said at least one subject image, for at least one selected purpose of: identification of the at least one subject, recognition of the at least one subject, matching of the at least one subject to at least one previously identified subject, targeting of the at least one subject, and or homing onto the at least one subject.

2. The data processing method of claim 1, wherein said at least one electromagnetic band is selected from a group of visible light band, infrared band, lasing band, X-ray band, radar band, and lidar band.
